(19) United States
(12) Patent Application Publication
(10) Pub. No.: US 2024/0378274 A1
(43) Pub. Date: Nov. 14, 2024

(54) MULTI-MODAL KINETIC BIOMETRIC AUTHENTICATION

(71) Applicant: Capital One Services LLC,, Mclean, VA (US)

(72) Inventors: Peter TANSKI, Marlborough, MA (US); Sze T. WONG, Allen, TX (US); Tate TRAVAGLINI, New York, NY (US)

(21) Appl. No.: 18/316,941

(22) Filed: May 12, 2023

(51) Int. Cl. G06F 21/32; G06N 20/00

(52) U.S. Cl. CPC G06F 21/32; G06N 20/00

(57) ABSTRACT

In some implementations, a device may obtain a set of biometric measurements, including a first type and a second type, at least one of the first type or the second type being a dynamic type. The device may evaluate the set of biometric measurements using a multi-modal artificial intelligence model, the multi-modal artificial intelligence model to generate an output prediction of a likelihood of the set of biometric measurements corresponding to stored characteristics of the single entity. The device may authenticate access for the single entity based on the output prediction from the multi-modal artificial intelligence model.

### BACKGROUND

In information security, “authentication” refers to techniques used to prove or otherwise verify an assertion, such as the identity of a user. For example, in some cases, authentication may be performed using biometrics, which generally include body measurements and/or calculations that relate to distinctive, measurable human characteristics. Biometric traits that are used for authentication are typically universal (e.g., every person possesses the trait), unique (e.g., the trait is sufficiently different to distinguish different individuals), and/or permanent (e.g., the trait does not significantly vary over time). Accordingly, because a biometric identifier is unique to a specific individual, biometrics can provide a more reliable and secure mechanism to verify a user identity and determine whether to grant the user access to systems, devices, and/or data, as compared to passwords and/or security tokens that may be lost, forgotten, or otherwise compromised (e.g., stolen or guessed by a malicious user).

### SUMMARY

Some implementations described herein relate to a system for multi-modal kinetic biometric authentication. The system may include one or more memories and one or more processors communicatively coupled to the one or more memories. The one or more processors may be configured to obtain a set of biometric measurements, corresponding to a set of types of biometric measurements, of a single entity, the set of biometric measurements including a first biometric measurement associated with a first type of the set of types, the set of biometric measurements including a second biometric measurement associated with a second type of the set of types, at least one biometric measurement, of the set of biometric measurements, being associated with a dynamic type of the set of types. The one or more processors may be configured to evaluate the set of biometric measurements using a multi-modal artificial intelligence model, the multi-modal artificial intelligence model to generate an output prediction of a likelihood of the set of biometric measurements corresponding to stored characteristics of the single entity. The one or more processors may be configured to authenticate access for the single entity based on the output prediction from the multi-modal artificial intelligence model.

Some implementations described herein relate to a non-transitory computer-readable medium that stores a set of instructions. The set of instructions, when executed by one or more processors of a system, may cause the system to obtain input data identifying a set of reference measurements, the set of reference measurements including a plurality of biometric measurements of a plurality of types. The set of instructions, when executed by one or more processors of the system, may cause the system to train the multi-modal artificial intelligence model using the input data. The set of instructions, when executed by one or more processors of the system, may cause the system to store information associated with the multi-modal artificial intelligence model in a data structure. The set of instructions, when executed by one or more processors of the system, may cause the system to obtain a set of biometric measurements, corresponding to a set of types of biometric measurements of the plurality of types of biometric measurements, of a single entity, the set of biometric measurements including a first biometric measurement associated with a first type of the set of types, the set of biometric measurements including a second biometric measurement associated with a second type of the set of types, at least one biometric measurement, of the set of biometric measurements, being associated with a dynamic type of the set of types. The set of instructions, when executed by one or more processors of the system, may cause the system to evaluate the set of biometric measurements using the multi-modal artificial intelligence model, the multi-modal artificial intelligence model to generate an output prediction of a likelihood of the set of biometric measurements corresponding to stored characteristics of the single entity. The set of instructions, when executed by one or more processors of the system, may cause the system to authenticate access for the single entity based on the output prediction from the multi-modal artificial intelligence model.

Some implementations described herein relate to a method for multi-modal kinetic biometric authentication. The method may include obtaining, by a system, a set of biometric measurements, corresponding to a set of types of biometric measurements, of a single entity, the set of biometric measurements including a first biometric measurement associated with a first type of the set of types, the set of biometric measurements including a second biometric measurement associated with a second type of the set of types, a plurality of biometric measurements, of the set of biometric measurements, being associated with a dynamic type of biometric measurement of the set of types of biometric measurements, each dynamic type of biometric measurement having a corresponding shape attribute and motion attribute. The method may include evaluating, by the system, the set of biometric measurements using a multi-modal artificial intelligence model, the multi-modal artificial intelligence model to generate an output prediction of a likelihood of the set of biometric measurements corresponding to stored characteristics of the single entity. The method may include authenticating, by the system, access for the single entity based on the output prediction from the multi-modal artificial intelligence model.

### BRIEF DESCRIPTION OF THE DRAWINGS

FIGS. 1A-1C are diagrams of an example implementation associated with multi-modal kinetic biometric authentication, in accordance with some embodiments of the present disclosure.

FIG. 2 is a diagram illustrating an example of training and using a machine learning model in connection with multi-modal kinetic biometric authentication, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with multi-modal kinetic biometric authentication, in accordance with some embodiments of the present disclosure.

FIG. 5 is a flowchart of an example process associated with multi-modal kinetic biometric authentication, in accordance with some embodiments of the present disclosure.

### DETAILED DESCRIPTION

The following detailed description of example implementations refers to the accompanying drawings. The same reference numbers in different drawings may identify the same or similar elements.

A virtual credential is a token or authentication that can be used to access a target computing system. A user device may complete an authentication process with an authentication system to gain access to the target computing system. For example, a user device may perform an authentication process with an authentication system to log a user of the user device into a secured website. In another example, the user device may perform an authentication process to obtain data from a secured data structure. In yet another example, the user device may perform an authentication process to initiate a transaction, such as via a payment processing platform.

One technique for completing an authentication process includes the use of a password or personal identification number (PIN). In this case, the user device may provide a user name and password to the authentication system, which may use the user name and password to determine if the user device is providing authentic credentials and whether to provide access to a target system. However, passwords and PINs are easily compromised or stolen, leading to unauthorized access and potential security breaches. Biometric authentication offers a more secure and reliable method of authentication. Biometric authentication is a process of identifying users based on unique, immutable biological characteristics, such as fingerprints, iris patterns, voice, or facial features. For example, a user device may scan a fingerprint or capture an image of a user and determine whether the fingerprint or the image of the user matches a reference (e.g., a stored fingerprint or a stored image). Biometric authentication may offer an advantage over other authentication methods, such as by enabling increased security, convenience, and/or efficiency. Additionally, biometric authentication may eliminate a need for users to remember passwords or carry access cards, reducing the risk of identity theft and fraud. Furthermore, biometric authentication can be completed within a few seconds and is less prone to human error than entering a password or PIN, which may reduce a consumption of computing resources relative to multiple failed password-based authentication attempts resulting from a user misremembering or mistyping a password.

However, biometric authentication processes use static information regarding a user, which, although potentially more secure than a password, is still subject to malicious attempts to compromise security. For example, it has been shown that some facial recognition systems are susceptible to spoofing attacks in which a malicious user positions a photograph of a genuine user in front of a camera, and the facial recognition system incorrectly determines that the genuine user is present in front of the camera. Similarly, some fingerprint readers are vulnerable to spoofing of fingerprints. In this case, an authentication system incorrectly admits a malicious user to a target system, which can compromise secure information or result in fraudulent transactions.

Additionally, reliance on static information regarding a user can result in a failure to correctly admit a genuine user. For example, an authentication system may fail to correctly authenticate a genuine user when the authentication system attempts to capture an image of the user under poor lighting conditions or when a user's facial expression deviates too much from a facial expression that the user used in a reference. Similarly, as a user ages, a user's face may change such that the authentication system no longer matches an image of the user against an old reference. In other words, some techniques for biometric authentication rely on an assumption that biometric characteristics of a user are immutable; however, in practice, some biometric characteristics of a user change (either from instance to instance or over a period of time). In this case, the authentication system may delay authenticating the user for a target system, resulting in additional image capture or the user having to provide additional credentials (e.g., a backup password or PIN) in lieu of using biometric authentication. As a result, the authentication system may waste network or device resources by failing to accurately authenticate a user of a user device.

Some implementations described herein may enable a dynamic biometric authentication by using a multi-modal artificial intelligence model trained on kinetic biometric data. A multi-modal artificial intelligence model is an artificial intelligence model that evaluates multiple different types of biometric measurements to determine whether, collectively, there is sufficient confidence to authenticate a user. In other words, the multi-modal artificial intelligence model may be trained on multiple types of biometric data and may evaluate received biometric measurements against the multiple types of biometric data to generate a prediction that the received biometric measurements are of a genuine user rather than a malicious user (or to identify a particular genuine user of a set of possible genuine users). Kinetic biometric data may include biometric data that is associated with movement or other changes. For example, an authentication system may receive a set of biometric measurements from a virtual reality device, which includes accelerometers and/or three-dimensional (3D) sensors to determine a gesture, a hand motion, a gait, a posture, a pupil dilation, an eye movement, or a facial movement, which may be compared against a reference to determine whether, for example, a measured facial movement matches a reference facial movement.

The kinetic biometric data may be combined with static biometric data or non-biometric data and evaluated as different modalities within the multi-modal artificial intelligence model. By using kinetic biometric data, the authentication system leverages sensing capabilities of different user devices to perform more accurate authentication determinations. Additionally, kinetic biometric data is more difficult for malicious actors to spoof (e.g., it may be more difficult to spoof a set of facial movements of a user than a static image of the user's face). Furthermore, by using a multi-modal artificial intelligence model, the authentication system reduces a likelihood of a failure to authenticate or a delay in authenticating a genuine user as a result of, for example, one type of biometric measurement not matching a reference. In other words, the authentication system can combine a voice print measurement matched to a reference with a high degree of confidence with a face print measurement that does not match a reference with a high degree of confidence (e.g., as a result of poor lighting or a different facial expression) to still authenticate a user. In this way, by providing an authentication system with a multi-modal artificial intelligence model and kinetic biometric data, information security is improved and resource utilization is reduced.

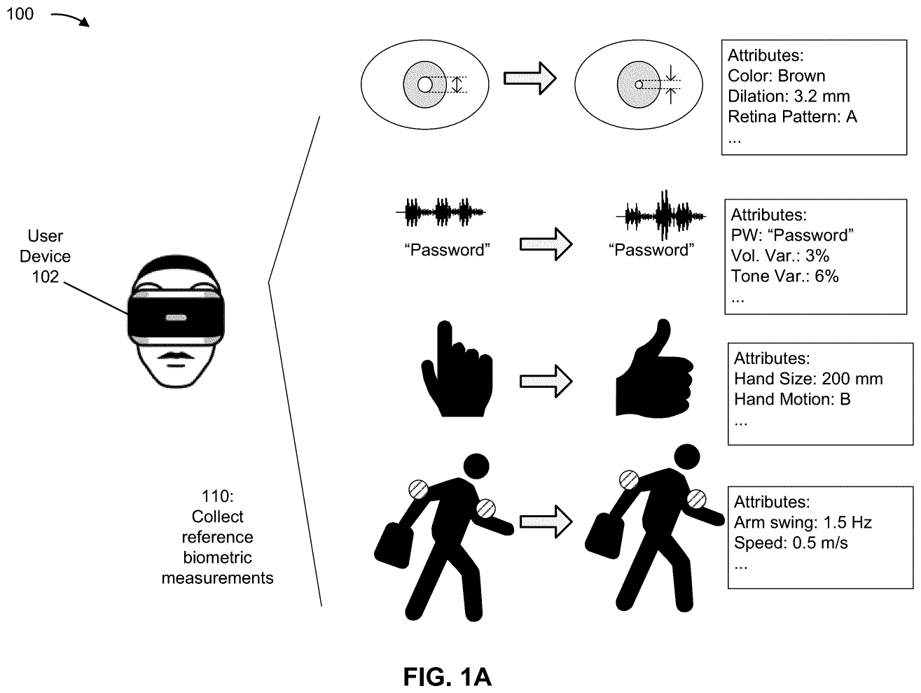

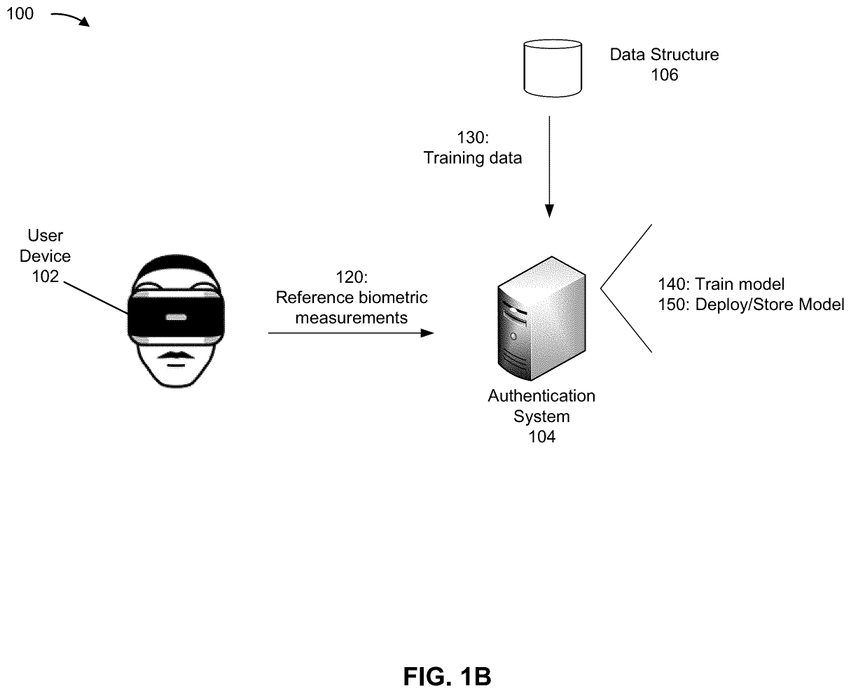

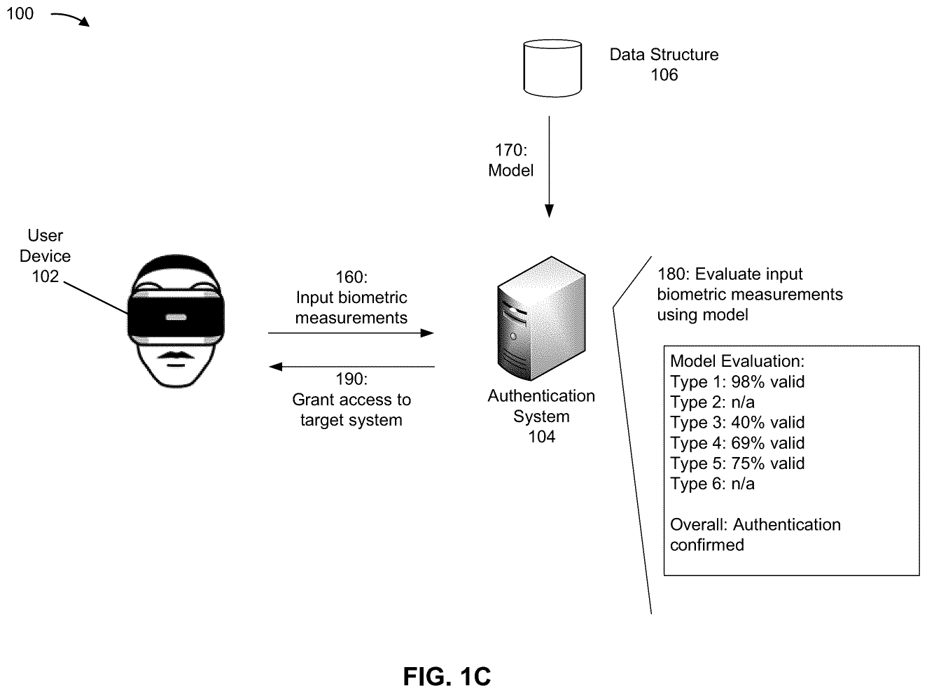

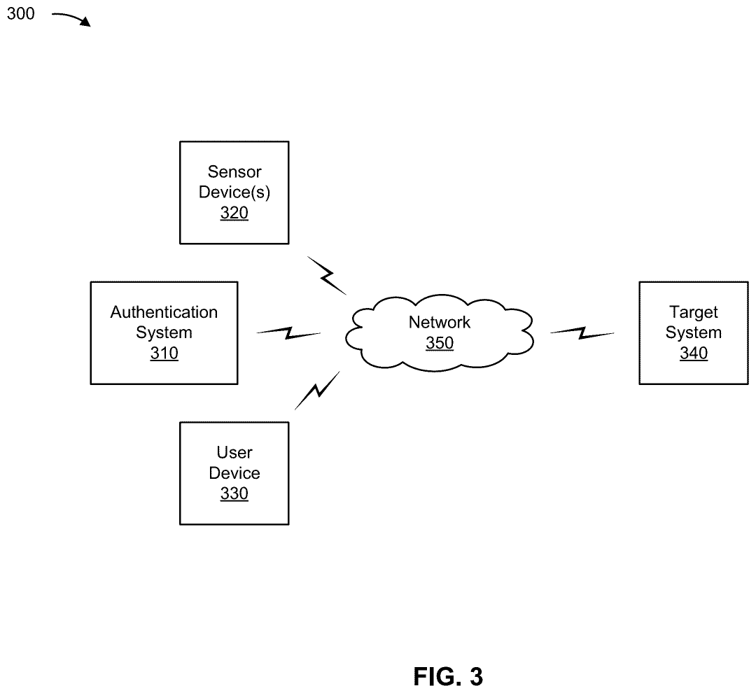

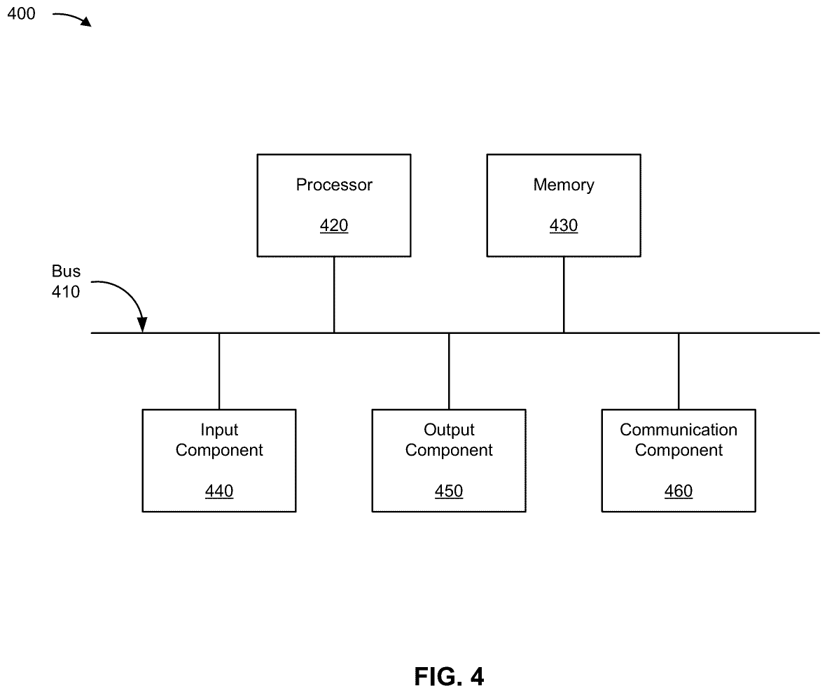

FIGS. 1A-1C are diagrams of an example implementation 100 associated with multi-modal kinetic biometric authentication. As shown in FIGS. 1A-1C, example implementation 100 includes a user device 102, an authentication system 104, and a data structure 106. These devices are described in more detail below in connection with FIG. 3 and FIG. 4.

As shown in FIG. 1A, and by reference number 110, the user device 102 may collect a set of reference biometric measurements. For example, the user device 102 may initiate an enrollment procedure or a programming mode, in which a set of reference biometric measurements are captured of a user to enable generation or training of a multi-modal artificial intelligence model. In some implementations, the user device 102 may collect the set of reference biometric measurements based on receiving an instruction. For example, the user device 102 may detect a user interaction with an input element of the user device 102, such as a user interface element, and may interpret the user interaction with the input element as a command to initiate the enrollment procedure. Additionally, or alternatively, the user device 102 may receive a command from the authentication system 104. For example, the authentication system 104 may determine to initiate enrollment of the user for biometric authentication and may transmit a command to the user device 102 to cause the user device to capture the set of reference biometric measurements.

In some implementations, the user device 102 may use one or more sensor elements to collect the set of reference biometric measurements. For example, the user device 102 may include one or more cameras (e.g., a 3D imaging camera), accelerometers, or microphones, among other examples. In this case, the user device 102 may monitor a set of sensors included therewith to capture one or more biometric measurements, such as performance of a movement (e.g., a gesture or a gait). Additionally, or alternatively, the user device 102 may communicate with one or more other devices, such as one or more peripheral devices or camera devices that may include sensor elements to capture reference biometric measurements. Additionally, or alternatively, the authentication system 104, as described in more detail below, may collect reference biometric measurements from a set of sensor elements, one or more of which may be included in the user device 102, in some implementations.

The set of reference biometric measurements may include kinetic biometric measurements, which may also be referred to as dynamic biometric measurements, or static biometric measurements, among other examples. Static biometric measurements may include a measurement of a fingerprint, a retinal scan, a vein pattern, or a face, among other examples. Kinetic biometric measurements may include measurements that have, among other attributes, a movement attribute. For example, a kinetic measurement of a user's hand may include an attribute relating to a shape or a size of the hand and an attribute relating to a movement of the hand (“Hand Motion”, as shown), such as a gesture. As another example, a kinetic measurement of a user's body may include an attribute relating to arm swing (e.g., a frequency of arm swing, speed, or an angular distance of arm swing), an attribute relating to gait, or another characteristic of the user's body measurable by imaging, accelerometer tracking, or another sensor measurement.

As another example, a kinetic measurement of a user's eye may include an attribute relating to a shape, color, or retina pattern of the eye, an attribute relating to an eye movement (e.g., a rate or pattern of eye movement), or an attribute relating to a pupil dilation (e.g., an amount of dilation under different lighting conditions or a rate of dilation in connection with a lighting condition change), among other examples. As another example, a kinetic measurement of a user's face may include an attribute relating to a shape of the face and an attribute relating to facial movement. In some implementations, a kinetic biometric measurement may be combined with a defined action. For example, a kinetic measurement of a user's eye or face may be performed while the user is speaking or gesturing (e.g., speaking a specific phrase, such as a password, or generally during speaking of any arbitrary phrase).

In some implementations, the user device 102 may prompt a user to perform a configured set of actions to enable capturing of biometric measurements associated with enrollment. For example, the user device 102 may direct a light toward a user's eye to measure pupil dilation associated with the light. Additionally, or alternatively, the user device 102 may provide a visualization of a hand gesture to guide the user in performing the hand gesture while measurements are captured of the hand gesture, an eye movement, or a facial movement. Similarly, the user device 102 may generate a password or phrase (or may receive a user selection of a password or phrase) for the user to say to enable capturing of a voice print and a set of kinetic measurements during vocalization of the password or phrase.

In some implementations, the user device 102 may obtain reference biometric measurements over a period of time. For example, the user device 102 may capture multiple instances of a user saying a password or performing a hand gesture over time to enable identification of a natural variance by the user. For example, as shown, the user device 102 may obtain reference biometric measurements of a user speaking a password (“Password”) multiple times to determine a volume variance (“Vol. Var.”) or a tone variance (“Tone Var.”) associated with different instances of speaking the password. Additionally, or alternatively, the user device 102 may periodically recapture reference biometric measurements to ensure that the reference biometric measurements are up-to-date with respect to any changes in a user's eye movements, hand gestures, gait, voice, or facial features.

In some implementations, the user device 102 may capture non-biometric information. For example, the user device 102 may capture a password or PIN to use as a backup when biometric authentication fails. Additionally, or alternatively, the user device 102 may capture location data or user device data (e.g., a device identity), which may be factors in an evaluation performed by the multi-modal artificial intelligence model, as described in more detail below.

As shown in FIG. 1B, and by reference numbers 120 and 130, the authentication system 104 may receive the set of reference biometric measurements and/or other training data for training a multi-modal artificial intelligence model. For example, the authentication system 104 may receive the set of reference biometric measurements from the user device 102 or one or more other devices, such as peripheral devices or cameras with sensor elements to capture reference biometric measurements of a user. Additionally, or alternatively, the authentication system 104 may receive other sets of reference biometric measurements associated with the user or other users from the data structure 106. For example, the authentication system 104 may receive reference biometric measurements regarding a set of users to train the multi-modal artificial intelligence model to identify users.

As further shown in FIG. 1B, and by reference numbers 140 and 150, the authentication system 104 may train the multi-modal artificial intelligence model and deploy and/or store the multi-modal artificial intelligence model. For example, the authentication system 104 may train the multi-modal artificial intelligence model using the set of reference biometric measurements and/or the training data, as described in more detail below. The authentication system 104 may store the multi-modal artificial intelligence model in, for example, the data structure 106 (or another data structure) and recall the multi-modal artificial intelligence model when the authentication system 104 is to use the multi-modal artificial intelligence model to authenticate a user. Additionally, or alternatively, the authentication system 104 may deploy the multi-modal artificial intelligence model to one or more user devices 102 to enable the one or more user devices 102 to use the multi-modal artificial intelligence model to authenticate a user. In this case, the authentication system 104 and/or the user device 102 may calibrate the multi-modal artificial intelligence model to a user device 102 (e.g., the authentication system 104 may calibrate the multi-modal artificial intelligence model to account for variances between sensor devices on different user devices 102 (e.g., different types of sensor devices or variances within a single type of sensor device, such as two cameras of a same type but with different brightness settings as a result of manufacturing differences or calibration differences)).

In some implementations, the authentication system 104 may train the multi-modal artificial intelligence model to detect motion resonances, which may also be referred to as resonance signatures, for one or more characteristics associated with a user. For example, the authentication system 104 may feed in a first biometric measurement of a characteristic (e.g., a first biometric measurement of a hand gesture), and a second biometric measurement of the characteristic (e.g., a second biometric measurement of the hand gesture). In this case, the authentication system 104 may train the multi-modal artificial intelligence model to identify motion resonances associated with performing the hand gesture. Motion resonances, or a resonance signature, may include natural variations that occur when performing a motion-based action, which may be unique or near-unique to a particular person. For example, a first person may have a first amount of variance in a hand path when performing a particular gesture, and a second person may have a second amount of variance in the hand path when performing the particular gesture. Additionally, or alternatively, a measurement may be performed over a threshold period of time to determine a variance during the threshold period of time. For example, the authentication system 104 may receive imaging of an eye that occurs over a threshold period of time (e.g., multiple seconds) and train the multi-modal artificial intelligence model to recognize a variance in pupil dilation, eye direction movement, etc., over the threshold period of time.

The authentication system 104 may train the multi-modal artificial intelligence model to detect an amount of variation over time or across different measurement instances and enable detection of a user based on the variance (e.g., in multiple measurements) or despite the variance (e.g., in a single measurement). In other words, when identifying a user, the multi-modal artificial intelligence model may be trained to receive two instances of measurements of a hand gesture and, based on a level of variation between the two instances (among other factors), identify that the user is genuine (e.g., based on an expected amount of variation). By using resonance signatures, the authentication system 104 reduces a likelihood of malicious spoofing by avoiding being fooled by, for example, a single video recording being replayed in front of a camera for each instance (e.g., spoofing with no variation). In another example, the authentication system 104 may train the multi-modal artificial intelligence model to receive a single instance of a measurement of a hand gesture and, based on a level of variation that is expected for the user, accurately identify that the single instance of the measurement is within an expected range of variation. By using resonance signatures, the authentication system 104 reduces a likelihood of failing to accurately identify a genuine user as a result of variations in the manner in which the genuine user completes, for example, a hand gesture.

In some implementations, the authentication system 104 may generate multiple artificial intelligence models. For example, the authentication system 104 may train a first artificial intelligence model to recognize hand gestures, a second artificial intelligence model to recognize eye movement, or a third artificial intelligence model to recognize facial movement, among other examples. In this case, training and using a multi-modal artificial intelligence model may correspond to the authentication system 104 training and using multiple artificial intelligence models, of multiple different biometric identification types, together to perform a biometric identification. In other words, the multiple artificial intelligence models may be used in combination by the authentication system 104 as a multi-modal artificial intelligence model for identifying a single entity (e.g., a particular user).

As shown in FIG. 1C, and by reference number 160, the authentication system 104 may receive a set of input biometric measurements for authentication. For example, the user device 102 may transmit a request that a user of the user device 102 be authenticated for a target system (e.g., a secured data structure, a secured website, or a transaction, among other examples). In some implementations, the authentication system 104 may receive biometric measurements associated with multiple different types. For example, the authentication system 104 may receive one or more static biometric measurements or one or more kinetic biometric measurements. Additionally, or alternatively, the authentication system 104 may receive non-biometric data, such as a password or PIN, a user device identity, time data, or location data that is used in connection with the set of biometric measurements (e.g., as an additional factor of authentication in a multi-factor authentication (MFA) process).

As shown by reference numbers 170 and 180, the authentication system 104 may obtain a multi-modal artificial intelligence model and evaluate the set of input biometric measurements using the multi-modal artificial intelligence model. For example, the authentication system 104 may determine a likelihood that the set of input biometric measurements (and/or accompanying non-biometric data) correspond to a particular user (e.g., indicating that the authentication request is from a genuine user and not a malicious user, or indicating that the authentication request is from a particular genuine user, of multiple possible users). In other words, the authentication system 104 may store data regarding a set of candidate entities (e.g., different possible users), and may evaluate a set of input biometric measurements to determine a likelihood that the set of input biometric measurements relate to a particular user among the set of candidate entities.

In some implementations, the authentication system 104 may generate a set of scores for a set of types of biometric measurements. For example, the authentication system 104 may determine, using the multi-modal artificial intelligence model, that a first biometric measurement is associated with a 98% likelihood of being valid (e.g., indicating that the authentication request is from a genuine user or from a particular genuine user of multiple possible users) and a second biometric measurement is associated with a 40% likelihood of being valid, among other examples. Additionally, or alternatively, the authentication system 104 may determine that one or more biometric measurements are not present. For example, when a user enrolls in biometric authentication with, for example, 6 different types of biometric measurements, the authentication system 104 may determine that one or more types of biometric measurements (e.g., “Type 2” and “Type 6”, as shown) are not provided or otherwise invalid.

In some implementations, the authentication system 104 may determine that an authentication request is valid based at least in part on multiple biometric measurements. For example, the authentication system 104 may combine scores for each type of biometric measurement, using the multi-modal artificial intelligence model, to determine whether a combined score for the set of biometric measurements satisfies a threshold. Additionally, or alternatively, the multi-modal artificial intelligence model may be associated with a threshold for each type of biometric measurement (e.g., a 95% validity threshold for a first measurement and a 70% validity threshold for a second measurement) and may determine that an authentication request is valid based on a particular quantity of biometric measurements satisfying respective thresholds.

In some implementations, the authentication system 104 may receive a first biometric measurement, determine that the first biometric measurement is not associated with a threshold validity level, and may request a second biometric measurement. For example, the authentication system 104 may receive first biometric data associated with a hand gesture, determine that the first biometric data does not result in the multi-modal artificial intelligence model outputting a threshold level of confidence in a prediction, and may request and receive second biometric data. In this case, based on inputting the second biometric data into the multi-modal artificial intelligence model, an output level of confidence may satisfy the threshold level of confidence resulting in the authentication system 104 authenticating the user device 102. Additionally, or alternatively, the authentication system 104 may receive multiple instances of biometric data. For example, the authentication system 104 may receive multiple measurements of a user's gait and may, after, for example, receiving gait measurements across a particular interval of time (e.g., 10 seconds), determine that a user can be authenticated with a threshold level of confidence. In this case, the authentication system 104 may provide feedback to the user (e.g., via a user interface element of the user device 102) to continue a particular action associated with generating biometric data (e.g., walking in the user's gait, performing a gesture, speaking a phrase, etc.).

As shown by reference number 190, the authentication system 104 may grant access to a target system. For example, the authentication system 104 may enable the user device 102 to access a secured data structure, access a secured website, complete a secured transaction, or perform another task for which user authentication is required. In some implementations, the authentication system 104 may update the multi-modal artificial intelligence model. For example, based on successfully identifying a user as genuine based on multiple different types of biometric measurements (e.g., eye measurements, hand measurements, voice measurements or other sound measurements, body measurements, facial measurements, or measurements of a portion of one or more of the foregoing, such as a measurement of a portion of a face, among other examples), the authentication system 104 may use one or more of the set of input biometric measurements to update the multi-modal artificial intelligence model. In this case, the authentication system 104 may update a resonance signature associated with a biometric measurement to, for example, account for a variance in an input biometric measurement relative to a reference biometric measurement on which the multi-modal artificial intelligence model had previously been trained. In this way, the authentication system 104 may use a successful authentication attempt to update a resonance signature, thereby accounting for variances between measurements or variances over time (e.g., changes to characteristics, such as changes to facial structure or voice over time).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

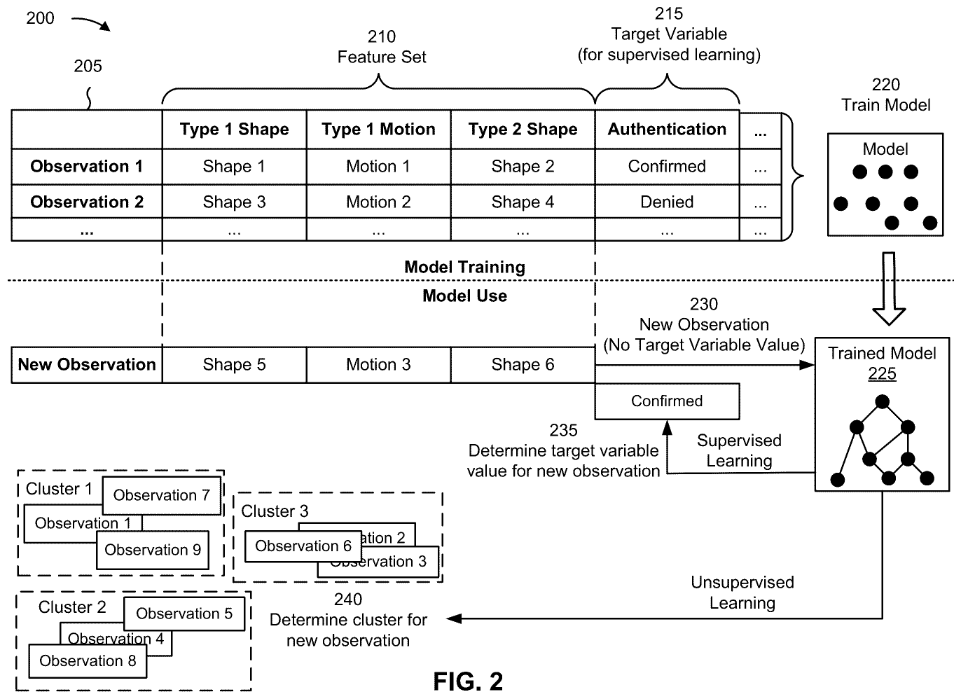

FIG. 2 is a diagram illustrating an example 200 of training and using a machine learning model in connection with multi-modal kinetic biometric authentication. The machine learning model training and usage described herein may be performed using a machine learning system. The machine learning system may include or may be included in a computing device, a server, a cloud computing environment, or the like, such as the authentication system 310 described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from a sensor device 320, a user device 330, or a data structure, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the sensor device 320, the user device 330, or a data structure. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a shape attribute of a first type of biometric measurement, a second feature of a motion attribute of a first type of biometric measurement, a third feature of a shape attribute of a second type of biometric measurement, and so on. As shown, for a first observation, the first feature may have a value of “Shape 1”, the second feature may have a value of “Motion 1”, the third feature may have a value of “Shape 2”, and so on. These features and feature values are provided as examples, and may differ in other examples. For example, the feature set may include one or more of the following features: kinetic biometric measurement attributes, non-kinetic biometric measurement attributes, or user identification information (e.g., non-biometric identification information), among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is an authentication determination, which has a value of “Confirmed” for the first observation.

The feature set and target variable described above are provided as examples, and other examples may differ from what is described above. For example, for a target variable of a resonance signature for a particular type of biometric measurement, the feature set may include different instances of the biometric measurement under different lighting conditions, at different times, or from different sensor devices, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. For example, the machine learning system may train a decision tree algorithm to determine whether one or more different types of biometric measurements can be verified as corresponding to a particular entity (e.g., a user) to a threshold degree of confidence, such that, collectively, the particular entity can be authenticated. Additionally, or alternatively, the machine learning system may train a support vector machine algorithm to classify a set of biometric measurements as corresponding to a particular user, in a group of possible users. After training, the machine learning system may store the machine learning model as a trained machine learning model 225 to be used to analyze new observations.

As an example, the machine learning system may obtain training data for the set of observations based on communicating with a user device or sensor device to enroll a user for biometric authentication. In this case, an authentication system may transmit a command to a user device to cause the user device to capture one or more biometric measurements, and the authentication system may receive information associated with the one or more biometric measurements as a response. Additionally, or alternatively, the authentication system may access a data structure storing biometric measurements to use as training data and/or other information from which biometric measurements can be derived (e.g., image data, video data, motion-capture data, or audio data, among other examples).

As shown by reference number 230, the machine learning system may apply the trained machine learning model 225 to a new observation, such as by receiving a new observation and inputting the new observation to the trained machine learning model 225. As shown, the new observation may include a first feature of “Shape 5”, a second feature of “Motion 3”, a third feature of “Shape 6”, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of “Confirmed” for the target variable of authenticating a user based on kinetic biometric measurements for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, authenticating a user. The first automated action may include, for example, granting the user (or a user device being used by the user) access to a target system.

As another example, if the machine learning system were to predict a value of “Denied” for the target variable of authenticating a user based on kinetic biometric measurements, then the machine learning system may provide a second (e.g., different) recommendation (e.g., reject authentication of a user) and/or may perform or cause performance of a second (e.g., different) automated action (e.g., capturing of additional biometric measurements or requesting entry of a backup credential, such as a password or PIN).

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a biometric measurement relates to a first user), then the machine learning system may provide a first recommendation, such as authenticating access to the target system for the first user (e.g., signing in a first user to a website). Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a biometric measurement relates to a second user), then the machine learning system may provide a second (e.g., different) recommendation (e.g., authenticating access to the target system for the second user, such as signing in the second user to a website) and/or may perform or cause performance of a second (e.g., different) automated action. As another example, if the machine learning system were to classify the new observation in a third cluster (e.g., a biometric measurement does not relate to a known user), then the machine learning system may provide a third (e.g., different) recommendation (e.g., rejecting authentication of access to the target system) and/or may perform or cause performance of a third (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model). For example, the feedback information may include biometric measurements from successful authentications. In other words, after a successful authentication, biometric measurements can be used to retrain or further refine the machine learning model 225. In one example, the machine learning system may use a first subset of biometric measurements captured regarding a single entity (e.g., a particular user) to authenticate a user and a second subset of biometric measurements captured regarding the single entity for refining the machine learning model 225 based on successful authentication using the first subset of biometric measurements. Alternatively, based on an unsuccessful authentication, the machine learning system may use the second subset of biometric measurements as a backup to re-evaluate authentication. In this way, the machine learning system can reduce processing associated with authentication (e.g., by evaluating fewer measurements for an initial authentication process), reduce network resources associated with backup authentication (e.g., by reserving the second subset of biometric measurements for backup authentication), and/or automate a process for updating the machine learning model 225 (e.g., by reserving the second subset of biometric measurements).

In this way, the machine learning system may apply a rigorous and automated process to biometric authentication. The machine learning system may enable recognition and/or identification of tens, hundreds, thousands, or millions of features and/or feature values for tens, hundreds, thousands, or millions of observations, thereby increasing accuracy and consistency and reducing delay associated with biometric authentication relative to requiring computing resources to be allocated for tens, hundreds, or thousands of operators to manually review biometric measurements and/or variance therein using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include an authentication system 310, one or more sensor devices 320, a user device 330, a target system 340, and a network 350. Devices of environment 300 may interconnect via wired connections, wireless connections, or a combination of wired and wireless connections.

The authentication system 310 may include one or more devices capable of receiving, generating, storing, processing, providing, and/or routing information associated with biometric authentication, as described elsewhere herein. The authentication system 310 may include a communication device and/or a computing device. For example, the authentication system 310 may include a server, such as an application server, a client server, a web server, a database server, a host server, a proxy server, a virtual server (e.g., executing on computing hardware), or a server in a cloud computing system. In some implementations, the authentication system 310 may include computing hardware used in a cloud computing environment. In some implementations, the authentication system 310 may be deployed on a user device 330. For example, the authentication system 310 may be a module of the user device 330 that performs authentication for users of the user device 330. Additionally, or alternatively, the authentication system 310 may communicate with the user device 330 and/or the sensor devices 320 to perform authentication of users of the user device 330.

The sensor device 320 may include one or more wired or wireless devices capable of receiving, generating, storing, transmitting, processing, detecting, and/or providing information associated with biometric authentication, as described elsewhere herein. For example, the sensor device 320 may include an image sensor, an audio sensor, a video sensor, a three-dimensional (3D) sensor, a LIDAR sensor, a motion capture sensor, accelerometer, a gyroscope, a proximity sensor, a light sensor, a noise sensor, a pressure sensor, an ultrasonic sensor, a chemical sensor (e.g., for biometric chemical authentication measurement), a positioning sensor, a capacitive sensor, an infrared sensor, an active sensor (e.g., a sensor that requires an external power signal), a passive sensor (e.g., a sensor that does not require an external power signal), a biological sensor, an analog sensor, and/or a digital sensor, among other examples. Additionally, or alternatively, the sensor device 320 may include a sensor element associated with a computer device, a security device (e.g., a secure entry system), a smart phone device (e.g., a smart phone camera), a transaction device (e.g., a payment device), or a wearable device (e.g., a smart health monitor), among other examples. The sensor device 320 may sense or detect a biometric measurement transmit, using a wired or wireless communication interface, an indication of the detected biometric measurement to other devices in the environment 300.

The user device 330 may include one or more devices capable of receiving, generating, storing, processing, and/or providing information associated with biometric authentication, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a wearable medical device, a pair of smart eyeglasses, a head mounted display, an augmented reality device, an extended reality device, or a virtual reality device), or a similar type of device.

The target system 340 may include one or more devices capable of receiving, generating, storing, processing, providing, and/or routing information associated with providing secured information, as described elsewhere herein. The target system 340 may include a communication device and/or a computing device. For example, the target system 340 may include a server, such as an application server, a client server, a web server, a database server, a host server, a proxy server, a virtual server (e.g., executing on computing hardware), or a server in a cloud computing system. In some implementations, the target system 340 may include a transaction backend system that enables performance of a transaction in connection with a transaction front-end (e.g., a payment portal). In some implementations, the target system 340 may include computing hardware used in a cloud computing environment.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with multi-modal kinetic biometric authentication. The device 400 may correspond to the authentication system 310, the sensor devices 320, the user device 330, and/or the target system 340. In some implementations, the authentication system 310, the sensor devices 320, the user device 330 and/or the target system 340 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

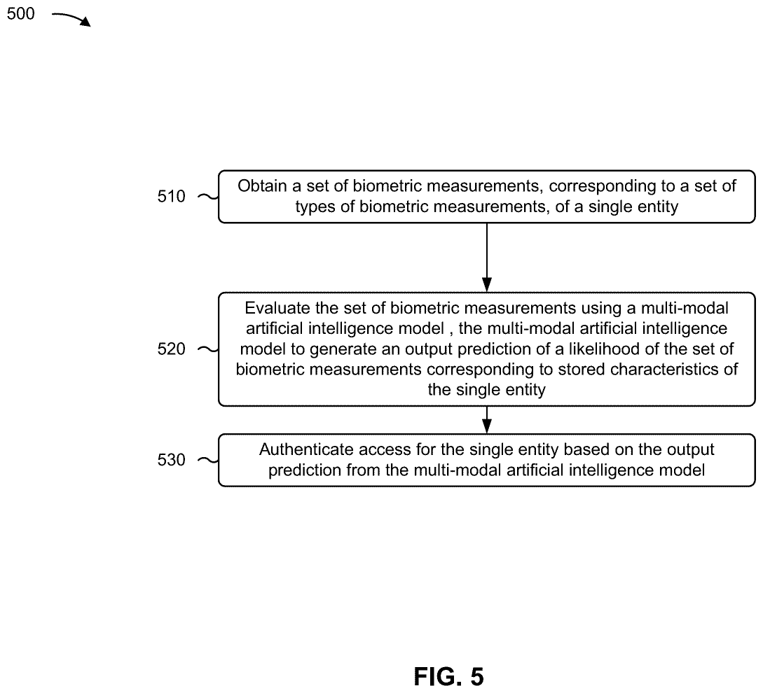

FIG. 5 is a flowchart of an example process 500 associated with multi-modal kinetic biometric authentication. In some implementations, one or more process blocks of FIG. 5 may be performed by the authentication system 310. In some implementations, one or more process blocks of FIG. 5 may be performed by another device or a group of devices separate from or including the authentication system 310, such as the sensor device 320, the user device 330, and/or the target system 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include obtaining a set of biometric measurements, corresponding to a set of types of biometric measurements, of a single entity (block 510). For example, the authentication system 310 (e.g., using processor 420 and/or memory 430) may obtain a set of biometric measurements, corresponding to a set of types of biometric measurements, of a single entity, as described above in connection with reference number 160 of FIG. 1C. As an example, the authentication system 310 may receive a measurement of a gesture, a measurement of an eye movement, or a measurement of a gait, among other examples. Although some implementations are described herein in terms of authentication of a single entity (e.g., a single person), the authentication system 310 can be configured to authenticate multiple entities (e.g., multiple persons) either individually (e.g., separate authentications of multiple persons being performed using imaging or measurements of the multiple persons concurrently) or collectively (e.g., a single authentication of multiple persons together, such as a group authentication). In some implementations, the set of biometric measurements includes a first biometric measurement associated with a first type of the set of types and the set of biometric measurements includes a second biometric measurement associated with a second type of the set of types. In some implementations, at least one biometric measurement, of the set of biometric measurements, is associated with a dynamic type of the set of types.

As further shown in FIG. 5, process 500 may include evaluating the set of biometric measurements using a multi-modal artificial intelligence model, the multi-modal artificial intelligence model to generate an output prediction of a likelihood of the set of biometric measurements corresponding to stored characteristics of the single entity (block 520). For example, the authentication system 310 (e.g., using processor 420 and/or memory 430) may evaluate the set of biometric measurements using a multi-modal artificial intelligence model, the multi-modal artificial intelligence model to generate an output prediction of a likelihood of the set of biometric measurements corresponding to stored characteristics of the single entity, as described above in connection with reference number 180 of FIG. 1C. As an example, the authentication system 310 may evaluate the measurements of a gesture, an eye movement, or a gait, among other examples, to determine a likelihood that the measurements identify the single entity. In some implementations, the authentication system 310 may combine likelihoods of accurate identification using each measurement to determine a combined likelihood, based at least in part on which the authentication system 310 may determine whether an accurate identification has been performed.

As further shown in FIG. 5, process 500 may include authenticating access for the single entity based on the output prediction from the multi-modal artificial intelligence model (block 530). For example, the authentication system 310 (e.g., using processor 420 and/or memory 430) may authenticate access for the single entity based on the output prediction from the multi-modal artificial intelligence model, as described above in connection with reference number 190 of FIG. 1C. As an example, the authentication system 310 may communicate with a target system to enable a user or a user device to access the target system or information associated therewith. Additionally, or alternatively, the authentication system 310 may communicate with a target system to grant physical access. For example, the target system may include an electronic lock that the authentication system 310 may disengage to enable a user to enter a secured location (e.g., a locked room or a locked cabinet).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for multi-modal kinetic biometric authentication, the system comprising:
one or more memories; and
one or more processors, communicatively coupled to the one or more memories, configured to:
obtain a set of biometric measurements, corresponding to a set of types of biometric measurements, of a single entity,
the set of biometric measurements including a first biometric measurement associated with a first type of the set of types,
the set of biometric measurements including a second biometric measurement associated with a second type of the set of types,
at least one biometric measurement, of the set of biometric measurements, being associated with a dynamic type of the set of types;
evaluate the set of biometric measurements using a multi-modal artificial intelligence model,
the multi-modal artificial intelligence model to generate an output prediction of a likelihood of the set of biometric measurements corresponding to stored characteristics of the single entity; and
authenticate access for the single entity based on the output prediction from the multi-modal artificial intelligence model.

2. The system of claim 1, wherein the one or more processors, to obtain the set of biometric measurements, are configured to:
transmit a command to at least one sensor to capture imaging of a field of view, the field of view including the single entity; and
obtain the imaging of the field of view as a response to the command.

3. The system of claim 1, wherein the one or more processors are further configured to:
obtain an authentication request including an identifier of the single entity; and
transmit a command to request the set of biometric measurements based on obtaining the authentication request.

4. The system of claim 1, wherein the one or more processors, to evaluate the set of biometric measurements, are configured to:
identify the single entity from a set of candidate entities for which corresponding characteristics are stored.

5. The system of claim 1, wherein the at least one biometric measurement includes imaging associated with a threshold time period, and
wherein the multi-modal artificial intelligence model is configured to evaluate a change to the imaging across the threshold time period.

6. The system of claim 1, wherein the set of biometric measurements includes a biometric measurement of at least one of:
a posture,
a motion,
a gesture, or
a sound.

7. The system of claim 1, wherein the set of biometric measurements includes a biometric measurement of at least one of:
a body,
a hand,
an eye,
a face, or
a portion of one of the foregoing.

8. The system of claim 1, wherein the one or more processors, to obtain the set of biometric measurements, are configured to:
obtain the set of biometric measurements from a sensor element of at least one of:
a virtual reality device,
an augmented reality device,
an extended reality device,
a transaction device,
a security device,
a computer device,
a wearable device,
a medical device, or
a smart phone device.

9. A non-transitory computer-readable medium storing a set of instructions, the set of instructions comprising:
one or more instructions that, when executed by one or more processors of a system, cause the system to:
obtain input data identifying a set of reference measurements,
the set of reference measurements including a plurality of biometric measurements of a plurality of types;
train a multi-modal artificial intelligence model using the input data; and
store information associated with the multi-modal artificial intelligence model in a data structure;
obtain a set of biometric measurements, corresponding to a set of types of biometric measurements of the plurality of types of biometric measurements, of a single entity,
the set of biometric measurements including a first biometric measurement associated with a first type of the set of types,
the set of biometric measurements including a second biometric measurement associated with a second type of the set of types,
at least one biometric measurement, of the set of biometric measurements, being associated with a dynamic type of the set of types;
evaluate the set of biometric measurements using the multi-modal artificial intelligence model,
the multi-modal artificial intelligence model to generate an output prediction of a likelihood of the set of biometric measurements corresponding to stored characteristics of the single entity; and
authenticate access for the single entity based on the output prediction from the multi-modal artificial intelligence model.

10. The non-transitory computer-readable medium of claim 9, wherein the one or more instructions further cause the system to:
obtain input data identifying a set of reference measurements of the single entity,
the set of reference measurements including a plurality of biometric measurements of a plurality of types,
the plurality of types including the set of types;
train the multi-modal artificial intelligence model using the input data; and
store information associated with the multi-modal artificial intelligence model in a data structure.

11. The non-transitory computer-readable medium of claim 10, wherein the one or more instructions, that cause the system to train the multi-modal artificial intelligence model, cause the system to:
generate at least one resonance signature for the single entity; and
wherein the one or more instructions, that cause the system to evaluate the set of biometric measurements, cause the system to:
compare the set of biometric measurements to the at least one resonance signature for the single entity.

12. The non-transitory computer-readable medium of claim 10, wherein the one or more instructions further cause the system to:
initiate a programming mode;
provide a user interface element, via a user interface of a device, identifying a movement that the single entity is to perform; and
monitor a set of sensors to detect performance of the movement; and
wherein the one or more instructions, that cause the system to obtain the input data, cause the system to:
obtain an output from the set of sensors, as the input data, based on monitoring the set of sensors to detect performance of the movement.

13. A method for multi-modal kinetic biometric authentication, comprising:
obtaining, by a system, a set of biometric measurements, corresponding to a set of types of biometric measurements, of a single entity,
the set of biometric measurements including a first biometric measurement associated with a first type of the set of types,
the set of biometric measurements including a second biometric measurement associated with a second type of the set of types,
a plurality of biometric measurements, of the set of biometric measurements, being associated with a dynamic type of biometric measurement of the set of types of biometric measurements,
each dynamic type of biometric measurement having a corresponding shape attribute and motion attribute;
evaluating, by the system, the set of biometric measurements using a multi-modal artificial intelligence model,
the multi-modal artificial intelligence model to generate an output prediction of a likelihood of the set of biometric measurements corresponding to stored characteristics of the single entity; and
authenticating, by the system, access for the single entity based on the output prediction from the multi-modal artificial intelligence model.

14. The method of claim 13, wherein the set of biometric measurements includes a biometric measurement of at least one of:
a body,
a hand,
an eye,
a face, or
a portion of one of the foregoing.

15. The method of claim 13, wherein obtaining the set of biometric measurements comprises:
obtaining the set of biometric measurements from a sensor element of at least one of:
a virtual reality device,
an augmented reality device,
an extended reality device,
a computer device,
a transaction device,
a security device,
a wearable device,
a medical device, or
a smart phone device.

16. The method of claim 13, further comprising:
obtaining input data identifying a set of reference measurements of the single entity,
the set of reference measurements including a plurality of biometric measurements of a plurality of types,
the plurality of types including the set of types;
training the multi-modal artificial intelligence model using the input data; and
storing information associated with the multi-modal artificial intelligence model in a data structure.

17. The method of claim 16, wherein training the multi-modal artificial intelligence model comprises:
generating at least one resonance signature for the single entity; and
wherein evaluating the set of biometric measurements comprises:
comparing the set of biometric measurements to the at least one resonance signature for the single entity.

18. The method of claim 16, further comprising:
initiating a programming mode;
providing a user interface element, via a user interface of a device, identifying a movement that the single entity is to perform; and
monitoring a set of sensors to detect performance of the movement; and
wherein obtaining the input data comprises:
obtaining an output from the set of sensors, as the input data, based on monitoring the set of sensors to detect performance of the movement.

19. The method of claim 13, wherein obtaining the set of biometric measurements comprises:
obtaining the set of biometric measurements from a plurality of devices.

20. The method of claim 13, wherein a biometric measurement, of the plurality of biometric measurements, is associated with a shape attribute and a motion attribute.
